(19) United States
(12) Patent Application Publication
(10) Pub. No.: US 2020/0130312 A1
(43) Pub. Date: Apr. 30, 2020

(54) Apparatus And Method For Forming Foldable Material Trays

(71) Applicant: innovative Fiber, LLC, Delafield, WI (US)

(72) Inventors: Jeffrey S. Covelli, Delafield, WI (US); Berger Hovland, Germantown, WI (US); Daniel Henne, Mazomanie, WI (US)

(21) Appl. No.: 16/665,686

(22) Filed: Oct. 28, 2019

Related U.S. Application Data
(60) Provisional application No. 62/750,987, filed on Oct. 26, 2018.

(51) Int. Cl. B30B 9/28; B30B 15/06; B30B 15/04

(52) U.S. Cl. CPC B30B 9/28; B30B 15/04; B30B 15/062

(57) ABSTRACT

An apparatus and method for forming a tray is provided including a forming plate and the complementary aperture in the mandrel formed to define a space therebetween that deforms the blank into the desired shape of the tray. The space between or tolerance defined by the forming plate and the mandrel is less than the actual thickness of the tray at one or more sections and/or points on the tray, such as at the corners of the tray, in order to crush the foldable material forming the tray at the one or more sections. The crushing of the foldable material at these sections effectively removes any shape memory from the foldable material, such that the tray including the crushed sections retains the shape of the tray without the need for additional securing materials on the tray but without degrading any leak-proof functionality of the tray.

### CROSS-REFERENCE TO RELATED APPLICATIONS

The present application claims priority from U.S. Provisional Patent Application Ser. No. 62/750,987, filed on Oct. 26, 2018, the entirety of which is expressly incorporated herein by reference for all purposes.

### FIELD OF THE DISCLOSURE

The present invention relates generally to foldable material, e.g., corrugated trays, and more specifically to an apparatus and process for forming trays from foldable material boards.

### BACKGROUND OF THE DISCLOSURE

When forming trays from foldable materials such as corrugated boards, i.e., materials having paperboard liners disposed on each side of a corrugated interior layer, blanks of the corrugated materials are run through a forming machine that deforms different portions of the boards in order to shape the board into the desired form for the tray. The forming machine utilizes a forming plate that presses the blanks through an aperture formed in a mandrel to deform the corrugated material blank and to fold portions of the blank relative to one another, which often overlaps portions of the blank to form joints or continuous surfaces, such as the corner and side walls of the tray. The shape of the forming plate and of the aperture in the mandrel are designed to configure the blank into precisely the desired form for the tray defined by the tolerances of the space between the forming plate and the mandrel without crushing any the corrugated material forming the blank.

However, due to the rigidity of the materials forming the corrugated boards which is necessary for proper functioning of the tray formed from the boards, the pressure applied to the boards via the forming machine is insufficient to overcome the shape memory of the corrugated boards. As a result, the blanks formed of the boards, and in particular the overlapped portions of the blanks at the corners of the tray, will tend to return to the original blank configuration of the boards after processing by the forming machine without additional securing or forming materials being used to hold the tray in the formed configuration.

To accommodate for and overcome this shape memory of the blank materials, in many instances, the added securing or forming materials come in the form of adhesives that are added to various portions of the blank material, e.g., corrugated board, as it is being formed in order to adhere portions of the board to one another and assist the board in retaining the desired shape of the tray. These adhesives are particularly useful in forming trays from the corrugated boards that are leak-proof as the adhesive provides a fluid barrier between the adhered portions of the boards.

However, when the corrugated boards are utilized to form trays for retaining food items therein for shipment and subsequent preparation by heating the tray and food item held therein, such as in an oven or microwave, the adhesives normally utilized in forming a tray are unsuitable. This is because the adhesives utilized are hot melt adhesives that degrade upon heating, and thus do not properly operate to hold the tray in the desired leak-proof configuration during preparation of the food items within the tray.

As a result, it is desirable to develop an apparatus and method for forming leak-proof trays from corrugated boards that enables the trays to retain their leak-proof configuration when heated, in certain embodiments without the use of any adhesive.

### SUMMARY OF THE DISCLOSURE

According to one aspect of the present disclosure, the apparatus and method utilizes a forming machine which includes a mandrel and forming plate each shaped to conform the foldable material blank passing through the mandrel into the desired configuration for a leak-proof tray. The forming plate forces the foldable, e.g., corrugated material blank through the aperture formed by the mandrel to deform portions of the corrugated material blank in order to shape the blank into the desired form for the tray. To form the tray, the forming plate and the complementary aperture in the mandrel are formed to define a space therebetween that deforms the blank into the desired shape of the tray. The space between or tolerance defined by the forming plate and the mandrel is less than the actual thickness of the tray at one or more sections and/or points on the tray, such as at the corners of the tray, in order to crush and/or compress the corrugated material forming the tray at the one or more sections. The crushing/compressing of the corrugated material at these sections effectively removes any shape memory from the corrugated material, such that the tray including the crushed/compressed sections retains the shape of the tray without the need for additional securing materials on the tray, such as any adhesive(s), but without degrading any leak-proof functionality of the tray.

Numerous other aspects, features, and advantages of the present disclosure will be made apparent from the following detailed description together with the drawings figures.

### BRIEF DESCRIPTION OF THE DRAWINGS

The drawings illustrate the best mode currently contemplated of practicing the present disclosure.

In the drawings:

FIG. 1 is a partially broken away perspective view of a forming machine constructed according to the present disclosure;

FIG. 2 is a partially broken away perspective view of the forming plate of the machine FIG. 1;

FIG. 3 is a partially broken away perspective view of a first exemplary embodiment of a mandrel of the forming machine of FIG. 1;

FIG. 4 is a partially broken away perspective view of a second exemplary embodiment of a mandrel of FIG. 3;

FIG. 5 is a partially broken away perspective view of the mandrel of FIG. 4 in a first step of forming a tray;

FIG. 6 is a partially broken away perspective view of the mandrel of FIG. 4 is a second step of forming a tray; and

FIG. 7 is a perspective view of an outlet chute of the mandrel of FIG. 4.

### DETAILED DESCRIPTION OF THE DISCLOSURE

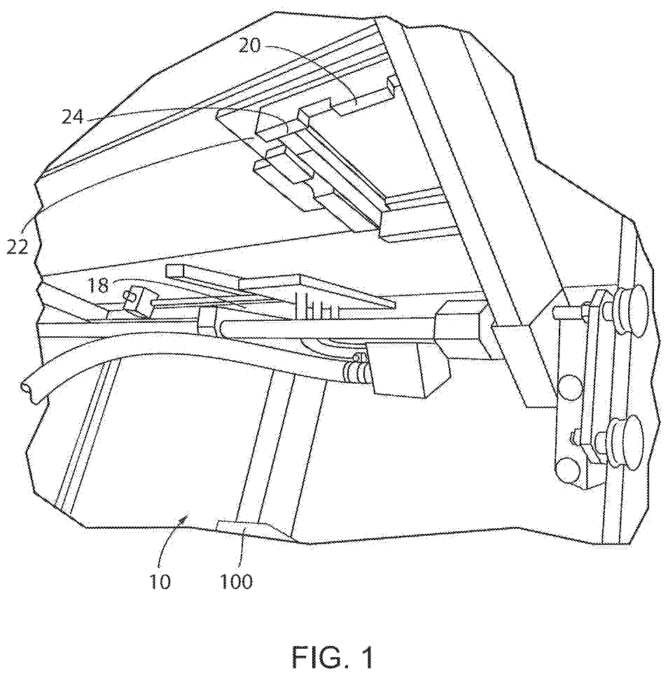

Referring now in detail to the drawing figures, wherein like reference numerals represent like parts throughout the several views, one embodiment of an apparatus constructed according to the present disclosure is illustrated generally at 10 in FIG. 1. The apparatus 10 is a forming machine that includes a blank supply (not shown) adapted to hold a number of blanks 14 of a corrugated material or other foldable material suitable for forming the blanks 14, such as a paperboard material or a plastic material, that can be utilized to form leak-proof trays 16. The supply 12 is disposed adjacent a picker 18 that is adapted to grasp, such as by suction, individual blanks 14 from the supply 12 for forming by the machine 10.

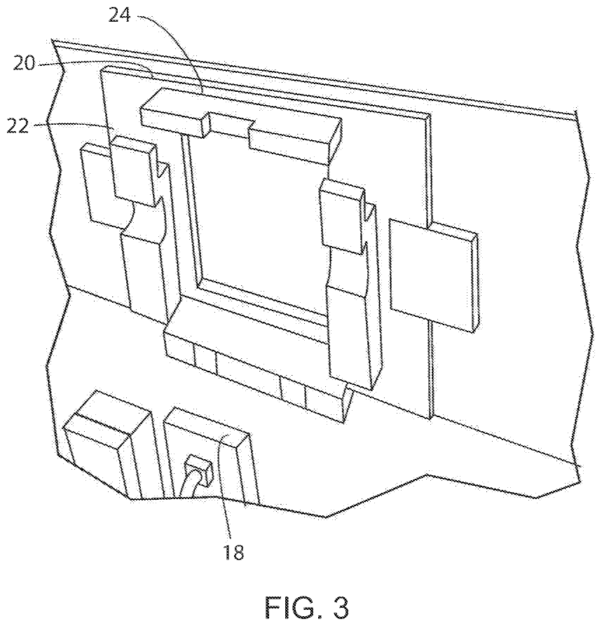

The picker 18 places the blank 14 within an aperture 20 defined within a mandrel 22. As best shown in FIGS. 1-3, the mandrel 22 includes a frame 24 that defines the shape of the aperture 20 and a number of deflection members 26 that engage portions of the blank 14, such as peripheral side edges 28 and ends 30, to form or move these portions 28,30 relative to a central portion 32 of the blank 14. The deflection members 26 can have any suitable configuration, and in the illustrated exemplary embodiment are formed of plastic blocks 27 having surfaces 29 tapered towards the aperture 20 in order to provide the desired deflection to the associated portions 28,30 of the blank 14. The blocks 27 can be releasably secured to the mandrel 22 in order to enable blocks 27 having different configurations to be utilized with the mandrel 22, as desired.

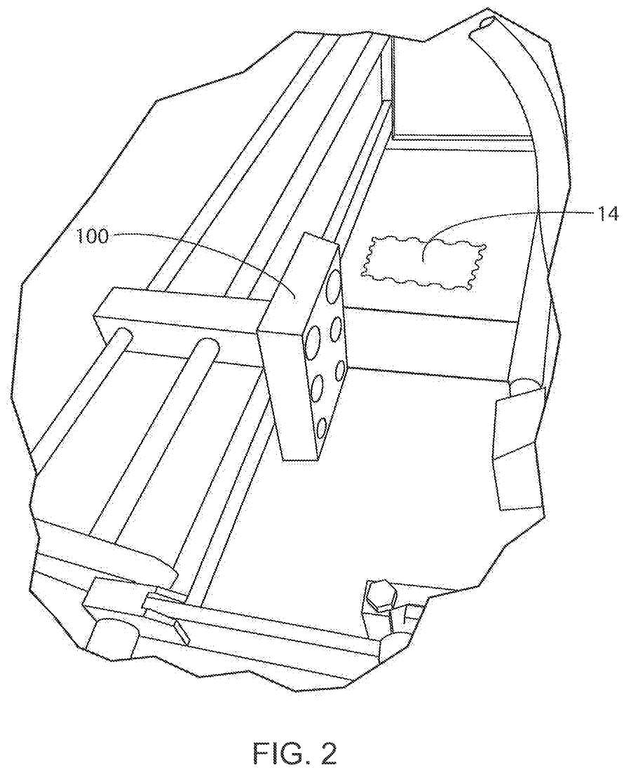

The blank 14 is driven into and through the mandrel 22 by a forming plate 100, best shown in FIG. 2. As the picker 18 moves away from the mandrel 22 after positioning the blank 14 partially within the mandrel 22 and/or aperture 20, the forming plate 100 engages the blank 14 and provides sufficient force to urge the blank 14 completely through the mandrel 22 and aperture 20 in order to form the blank 14 into the desired shape for the tray 16. The formed trays 14 exit the mandrel 22 and aperture 20 into a chute 102 connected to the mandrel 22 opposite the picker 18 and forming plate 100 to direct the formed trays 16 away from the mandrel 22 to enable formation of additional trays 16 from blanks 14 subsequently positioned within the aperture 20 by the picker 18.

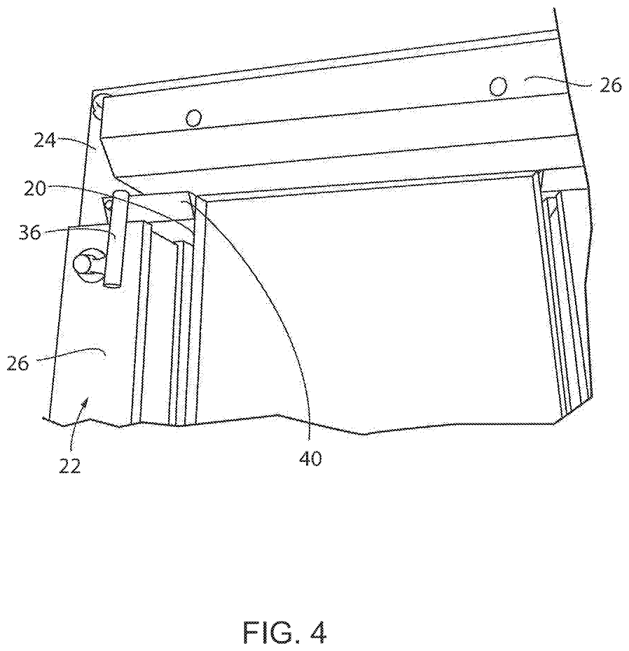

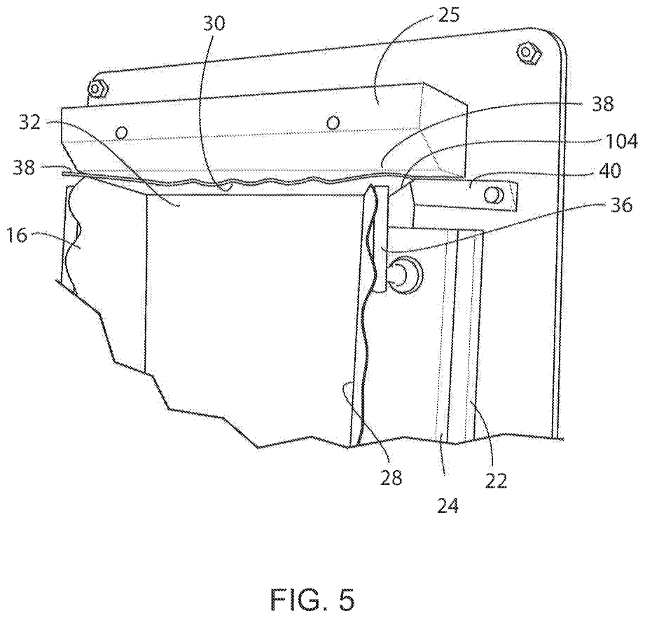

Concerning the formation of the blank 14 into the tray 16 by the engagement of the blank 14 by the forming plate 100 and mandrel 22, as best shown in FIGS. 4-6, with particular regard to the corners 34 of the blank 14, to form the leak-proof tray 16 the side walls 28 and ends 30 are initially folded with respect to the central portion 26 by engagement of the side walls 28 and ends 30 with the adjacent deflection members 26 on the mandrel 22. From this initial position, the overlapping portions 38 of the side walls 28 and ends 30 are subsequently aligned and folded against one another by a folding rod 36 (FIG. 5) located on the frame 24 and spaced from the aperture 20 to locate the overlapping portions 38 parallel to the end 30. In this configuration the end 30 is pressed against the side wall 28 to assist in providing the leak-proof functionality to the corner 34.

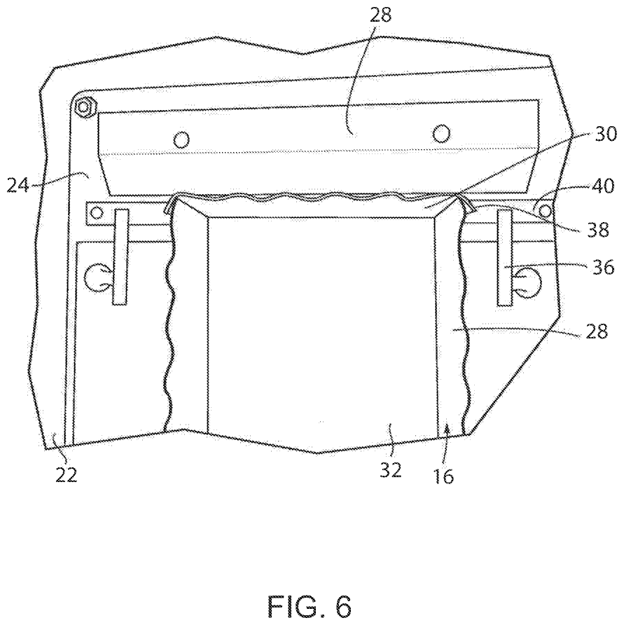

A folding tab 40 downstream from the rod 36 and disposed on the frame 24 between the rod 36 and the aperture 20 (FIG. 6) engages, deflects and folds the aligned overlapping portions 38 of the side wall 28 and the end 30 against the side wall 28 into the initial configuration for the tray 16. The folding tab 40 is oriented perpendicularly to the folding rod 36 in the illustrated exemplary embodiment, though other orientations for the tab 40 and the rod 36 are also within the scope of the present disclosure in order to provide the desired shape for the tray 16.

In the illustrated exemplary embodiment, in the initial configuration of the tray 16 as it passes the tabs 40, each corner 34 includes three (3) thicknesses of the foldable or corrugated material forming the blank 14 used to create the tray 16, namely, the side wall 28 and the two (2) overlapping portions 38 disposed immediately adjacent the side wall 28. However, other thicknesses are also within the scope of the invention depending upon the desired configuration for the tray 16. In this initial configuration, the forming plate 100 drives the tray 16 through the aperture 20 to cause the tray 16 and the component parts thereof to move into the final configuration for the tray 16. In doing so, the forming plate 100 moves into the aperture 20 to define a space 104 between the forming plate 100 and the frame 24 of the mandrel 22. The space 104 is selected to have a width from the forming plate 100 to the mandrel frame 24 of less than the thickness of the corners 34 of the initial configuration of the tray 16. The reduction in the width of the space 104 defined between the forming plate 100 and the mandrel frame 24 effectively compresses or crushes the corners 34 of the tray 16. The size of the space 104 enables the corners 34 to be engaged between the frame 24 and the forming plate 100 to compress the corners 34, and is selected to be less than the number of thicknesses of the material of the blank 14 forming the corners 34, which can be between less than one (1) thickness of the material and up to less than four (4) thicknesses of the material. In a particular exemplary embodiment of the machine 10, the width of the space 104 is selected to be approximately equal to the width of two (2) thicknesses of the corrugated material forming the blank 14. In an exemplary embodiment, this width for the space 104 can either extend completely around the aperture 20 or at selected sections of the aperture 20, such as at the sections of the aperture 20 through which the corners 34 pass. In this embodiment, as the remainder of the tray 16 outside of the corners 34 has a thickness of only one (1) thickness of the corrugated material, i.e., the thickness of the side wall 28 or the end 30, the crushing force applied by the forming plate 100 and the mandrel frame 24 as the tray 16 is moved through the aperture 20 by the forming plate 100 is limited to application on the corners 34 of the tray 16. Further, as the foldable material forming the blank 14 can be formed of a corrugated, paperboard or plastic material, in certain exemplary embodiments the thickness of the material forming the blank 14 is between about 0.010 inches and about 0.500 inches, or between about 0.0625 inches and about 0.250 inches, including various standard flute sizes, such as A, B, C, E and F flute size corrugated materials.

The crushing forces applied to the corners 34 of the tray 16 based on the reduced size of the space 104 in the aperture 20 through which the tray 16 is pushed by the forming plate 100 effectively removes the shape memory of the corrugated material forming the corners 34 of the tray 16. As such, after passing through the mandrel 22, the corners 34 of the tray 16 effectively remain in the final configuration for the tray 16 even without the application of any additional securing or forming materials to the tray 16. Thus the tray 16 can effectively be utilized to hold food items for shipment and later heating as the corners 34 will retain their shape during the process of heating/preparation of the food items within the tray 16.

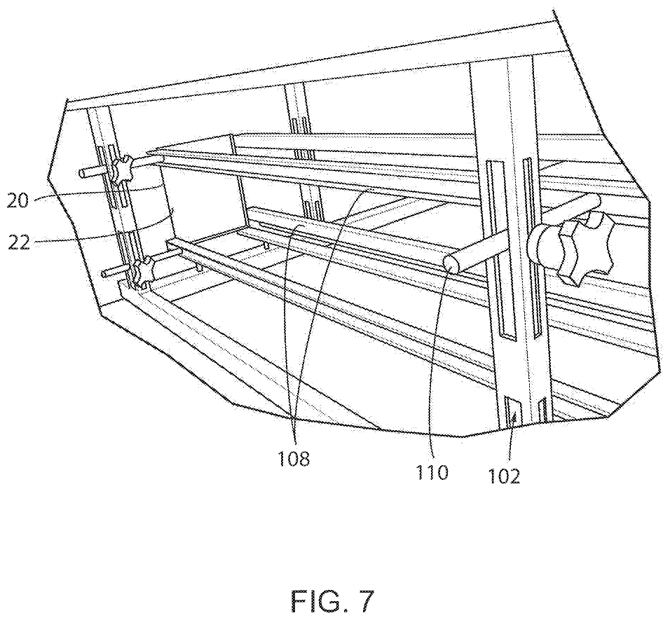

After passing through the aperture 20, the tray 16 including the compressed or crushed corners 34 can be retained within the chute 102, best shown in FIG. 7. The chute 102 is formed of a number of rails 108 that are movably mounted to a number of guide rods 110 that extend away from the mandrel 22 opposite the forming plate 100. The positioning of the rails 108 enables the trays 16 including the crushed corners 34 to be retained in the final formed configuration after exiting the mandrel 22. The chute 102 thus provides added time under compression to the trays 16 to assist in the corners 34 maintaining the final configuration for the tray 16 after removal from the chute 102. In a particular exemplary embodiment, the tray 16 is retained under compression within the chute for at least one (1) minute or at least two (2) minutes to enable the crushed corners 34 to fully retain their shape after removal from the chute 102.

In another exemplary embodiment of the disclosure the frame 24 of the can optionally include a number of adhesive dispensers (not shown) that can apply an amount of adhesive to the overlapping portions 38 prior to engagement with the folding tabs 40. The adhesive added to the overlapping portions 38 assists in securing the overlapping portions 38 against the adjacent side wall 28 prior to the application of the crushing force to the corners 34 formed of the overlapping portions 38 and the side walls 28.

Changes can be made in the above constructions and method steps without departing from the scope of the invention, it is intended that all matter contained in the above description or shown in the accompanying drawings shall be interpreted as illustrative and not in a limiting sense. Various other embodiments of the present invention are contemplated as being within the scope of the filed claims particularly pointing out and distinctly claiming the subject matter regarded as the invention.

1. An apparatus for forming a foldable material tray, the apparatus comprising:
a. a mandrel including a frame defining an aperture; and
b. a forming plate selectively positionable within the aperture to define a space between the frame and the forming plate having a width less than a thickness of at least a portion of the tray formed of the foldable material.

2. The apparatus of claim 1 wherein the mandrel comprises a number of deflection members attached around the aperture.

3. The apparatus of claim 2 wherein the deflection members include a tapered surface sloping towards the aperture.

4. The apparatus of claim 1 wherein the mandrel further comprises a folding rod disposed on the mandrel and spaced from the aperture.

5. The apparatus of claim 4 wherein the mandrel includes a folding tab disposed on the mandrel between the folding rod and the aperture.

6. The apparatus of claim 5 wherein the space is defined between the forming plate and a perimeter of the aperture.

7. The apparatus of claim 5 wherein the folding tab and the folding rod are oriented perpendicularly to one another.

8. The apparatus of claim 1 wherein the mandrel includes a folding tab disposed on the mandrel and spaced from the aperture.

9. The apparatus of claim 1 wherein the space defined between the forming plate and the frame is selected to be between less than one (1) thickness of the foldable material and up to less than four (4) thicknesses of the foldable material.

10. The apparatus of claim 9 wherein the space defined between the forming plate and the frame is selected to be two (2) thicknesses of the foldable material.

11. The apparatus of claim 10 wherein the space does not extend completely around a perimeter of the aperture.

12. The apparatus of claim 10 wherein the foldable material is a corrugate material.

13. The apparatus of claim 1 further comprising a chute secured to the frame and extending outwardly from the frame opposite the forming plate.

14. The apparatus of claim 13 wherein the chute includes a number of rails defining the chute with a perimeter equal to the aperture in the frame.

15. A method for forming a foldable material tray, the method comprising the steps of:
a. providing a forming machine including a mandrel including a frame defining an aperture and a forming plate selectively positionable within the aperture to define a space between the frame and the forming plate less than a thickness of at least a portion of the tray formed of the foldable material; and
b. pressing a blank of foldable material through the aperture with the forming plate to crush selected sections of the corrugated material to remove shape memory from the foldable material to form the tray.

16. The method of claim 15 wherein the forming machine additionally includes a chute attached to the frame around the aperture and extending away from the frame opposite the forming plate, and further comprising the steps of:
a. passing the tray from the aperture into the chute after pressing the blank through the aperture to form the tray; and
b. retaining the tray within the chute for at least one minute.
